(19) United States
(12) Patent Application Publication
(10) Pub. No.: US 2022/0183259 A1
(43) Pub. Date: Jun. 16, 2022

(54) WIRELESSLY VOICE CONTROLLED DOG COLLAR

(71) Applicant: Courtney Oswald, Rocky River, OH (US)

(72) Inventor: Courtney Oswald, Rocky River, OH (US)

(21) Appl. No.: 17/478,272

(22) Filed: Sep. 17, 2021

Related U.S. Application Data
(60) Provisional application No. 63/124,311, filed on Dec. 11, 2020.

(51) Int. Cl. A01K 27/00; H04W 4/029; H04W 4/80

(52) U.S. Cl. CPC A01K 27/009; H04W 4/80; H04W 4/029; A01K 27/001

(57) ABSTRACT

The present invention relates to a wirelessly and voice-controlled dog collar. The collar features a speaker system to play out voice commands transmitted wirelessly by a dog owner from an electronic device having an installed training application or from a handheld transmitter. The collar fits around the neck of a dog, and is wirelessly-connected to the electronic device or the handheld transmitter through a wireless communication channel. Location of the collar and the images captured from the camera on the collar are transmitted to the electronic device and the handheld transmitter in real-time through the wireless channel.

### CROSS-REFERENCE TO RELATED APPLICATION

The present application claims priority to, and the benefit of, U.S. Provisional Application No. 63/124,311, which was filed on Dec. 11, 2020 and is incorporated herein by reference in its entirety.

### FIELD OF THE INVENTION

The present invention relates generally to the field of dog collars. More specifically, the present invention relates to a wireless voice-controlled dog collar that is configured to receive voice commands to train dogs to perform the actions corresponding to the voice commands. The voice command collar enables dog owners to correct their dog's behavior and train them by transmitting voice commands from a remote electronic device having a companion application or a handheld transmitter. The voice command collar of the present invention resembles a regular dog collar, but includes a housing having a GPS unit, a wireless communication module, speaker system and more. Applications of the voice-controlled dog collar include recovery of a lost or stolen dog, facilitating communication during a hunting exercise and pet training purposes. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, animal collars, especially dog collars are necessary devices for identifying the animal and the owner's information. A dog collar is a piece of material placed around the neck of a dog for control, identification or other purposes. There are a large number of dog collars currently available, with varieties to suit many different situations and a wide spectrum of dog sizes. Most of these collars will have an attachment mechanism of some sort, whereby the collar can be releasably-secured to a leash, such that the dog can be walked, trained or otherwise restrained, depending upon the circumstances. However, conventional dog collars are basic collars, and do not provide additional functionality such as aiding in training of a dog or helping in locating a lost dog.

Generally, to ensure safety of a domesticated house pet such as a dog and to prevent the pet from becoming lost, most owners keep their pets indoors, enclosed within a fenced area or tethered to a location or run line such that they are prohibited from wandering away. Also, domesticated house pets, whether in home or outdoors, are typically tied to a leash as the pet owners want to be physically close for monitoring and training the pet. This prohibits a pet's outdoor freedom.

Further, hunters generally direct their hunting dogs in a field or woods from a distance, and due to the distance between the hunter and the dog, the dog may be unable to hear properly. Hunters desire a device that can help them direct their hunting dogs even from a distance without fear of losing them.

In cases where a pet such as a dog is not on a leash, the pet may wander out of earshot and may become lost. Sometimes, pets stray from their home and become lost. In such situations, direction communication is required between the pet and the owner, even though the pet owner is not physically present near the pet. Also, in noisy areas, it may become hard for a pet to hear instructions from his or her owner allowing them to be a nuisance which may be troublesome for others. In such cases, users may desire a device that allows them to control their pets without raising their voices.

Many pet owners want to track the location of their pets while walking with them and when they are away from them. However, conventional collars do not provide this functionality. For example, pet owners may have difficulty trying to find a location tracker that can be attached to a dog or other pet. It would be convenient to have a device that can be worn by a dog or other pet without any discomfort, and which is able to track the location of the dog or other pet.

Therefore, there exists a long felt need in the art for a device that can be used for training and controlling pets, especially dogs, without using a leash. There is also a long felt need in the art for a device that allows dog owners to have direct communication with their dogs, even from a moderate distance. Additionally, there is a long felt need in the art for a device that enables pet owners to maintain clear, concise communication with their dogs while off their leash. Moreover, there is a long felt need in the art for a device that enables dog owners to give commands to their dogs conveniently from their devices, without shouting or raising their voice. Further, there is a long felt need in the art for a device that enables pets to maintain their outdoor freedom while also remaining safe and able to hear their owners. Finally, there is a long felt need in the art for a device that is convenient to use and provides enhanced features to pet owners to train and control their pets.

The subject matter disclosed and claimed herein, in one embodiment thereof, comprises a voice-controlled dog collar device. The dog collar device comprises a band structure having a buckle and a clip to secure the dog collar device around the neck of a dog. The dog collar device further includes a wireless communication module for establishing a wireless communication channel with a remote electronic device or a handheld transmitter, a speaker for playing out voice commands received from the remote electronic device or the handheld transmitter wherein the played out voice commands are used for training the dog wearing the collar, a vibration sensor for generating a vibration while the speaker plays out a received voice command, a camera to capture an image around the collar, a location detector for detecting the current location of the collar and a USB charging port for recharging an internal battery. The captured image and current location of the collar are transmitted to the remote electronic device or the handheld transmitter using the wireless communication channel.

In this manner, the novel voice command collar device of the present invention accomplishes all of the forgoing objectives, and provides a relatively easy, convenient and efficient solution of allowing pet owners to train their pets, such as dogs and other pets, and control the behavior of their pets even from a moderate distance. The voice command collar device of the present invention also allows a pet owner to maintain contact with the dog or other pet while off their leash. The speaker unit plays out voice commands enabling the pets to roam free while still being able to hear their owner for training and controlling purposes. Additionally, the voice command collar prevents pets from straying away from the supervision of their pet owners.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a voice command dog collar device. The voice command dog collar device is configured to connect wirelessly to a remote electronic device or a handheld transmitter. The voice command dog collar device further comprises a band for wrapping around the neck of a dog, a housing attached to the band which includes components including a wireless communication module for establishing a wireless communication channel with the remote electronic device or the handheld transmitter, a speaker for playing out voice commands received from the remote electronic device or the handheld transmitter, wherein the played-out voice commands are used for training the dog wearing the collar, a vibration sensor for generating a vibration while the speaker plays out a received voice command, a camera to capture an image around the collar, a location detector for detecting the current location of the collar and a USB charging port for recharging an internal battery. The captured image and the current location of the collar are transmitted to the remote electronic device or the handheld transmitter using the wireless communication channel.

In yet another embodiment of the present invention, the housing has a volume up button to increase the volume of the speaker, and a volume down button to decrease the volume of the speaker. A control button is disposed on the housing to activate or deactivate the components of the housing.

In yet another embodiment, a pet training collar device is disclosed. The pet training collar device comprises an elongated band having clips at one end for fastening around a neck of a pet, said band having an attached housing that includes a plurality of electronic components for training the dog wearing the collar, wherein the components include a wireless communication module, a speaker unit, a location detector, a USB charging port, a camera and a vibration sensor. Further, the wireless communication module establishes a Bluetooth channel with a smartphone or a handheld transmitter for receiving voice commands for training the dog, said voice commands are played out by said speaker, thereby allowing a dog owner to train and control the dog from a moderate distance without the use of a leash.

In yet another embodiment of the present invention, a method for training and controlling a dog using a voice-controlled dog collar device is disclosed. The method includes initially placing the voice-controlled dog collar device around the neck of the dog, pairing the collar with a remote smartphone having a training software application installed therein, or a handheld transmitter using a wireless communication channel, receiving, via the dog collar, one or more voice commands from said paired smartphone or said handheld transmitter which utilizes said wireless communication channel, playing out the voice commands via an integrated speaker within the dog collar which allows for training and controlling the dog remotely, and transmitting the real time location of the collar and the images around the collar to said paired smartphone or said handheld transmitter using said wireless communication channel.

In yet another embodiment of the present invention, the voice-controlled dog collar device establishes direct communication between a dog owner and the dog for training and monitoring. A dog owner does not need a leash, nor does a dog owner need to be very close to the dog for training and controlling the dog.

In yet another embodiment of the present invention, a computer-readable storage medium comprising instructions that are executed by a processor of an electronic device is disclosed. The instructions cause the processor of the electronic device to establish a wireless communication channel with a voice-controlled dog collar device using a wireless interface, to transmit voice commands to the paired dog collar using the wireless communication channel, to receive real-time images and location information from the paired dog collar, and to display the received real-time images and location information.

In yet another embodiment of the present invention, a handheld transmitter for communicating with a communication collar device is disclosed. The handheld transmitter comprises a wireless interface for establishing a wireless communications channel with a voice-controlled dog collar, a microphone to capture voice command for transmission to the voice-controlled dog collar and a display for displaying received real-time location and images from the voice-controlled dog collar.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a wireless voice-controlled dog collar device of the present invention in accordance with the disclosed architecture;

FIG. 2 illustrates a schematic view showing the wireless connection of the wireless voice-controlled dog collar device of the present invention with a paired smartphone application for receiving voice commands in accordance with the disclosed architecture;

FIG. 3 illustrates a schematic view of the wireless voice-controlled dog collar device of the present invention receiving a voice command from the dog owner through a handheld transmitter in accordance with the disclosed architecture;

FIG. 4 illustrates an exemplary flow diagram showing the steps of use of the wireless voice-controlled dog collar device of the present invention for training and controlling dogs in accordance with the disclosed architecture;

FIG. 5 illustrates an exemplary user interface of the training software application for communicating with the wireless voice-controlled dog collar device of the present invention in accordance with the disclosed architecture; and

FIG. 6 illustrates an exemplary electronic device upon which the training application of the present disclosure is implemented in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As stated supra, there exists a long felt need in the art for a device that can be used for training and controlling pets, especially dogs, without using a leash. There is also a long felt need in the art for a device that allows dog owners to have direct communication with their dogs even from a moderate distance. Additionally, there is a long felt need in the art for a device that enables pet owners to maintain clear and concise communication with their dogs while off leash. Moreover, there is a long felt need in the art for a device that enables dog owners to give commands to their dogs conveniently from their devices, without shouting or raising their voice. Further, there is a long felt need in the art for a device that enables pets to maintain their outdoor freedom while also remaining safe and able to hear their owners. Finally, there is a long felt need in the art for a device that is convenient to use and provides enhanced features to pet owners to train and control their pets.

The present invention, in one exemplary embodiment, is a pet training collar device. The pet training collar device comprises an elongated band having clips at one end for fastening around a neck of a pet, said band having an attached housing that includes a plurality of electronic components for training the dog wearing the collar. The components include a wireless communication module, a speaker unit, a location detector, a USB charging port, a camera, and a vibration sensor, wherein said wireless communication modules establishes a Bluetooth channel with a smartphone or a handheld transmitter for receiving voice commands for training of the dog. Further, the voice commands are played out by the speaker, thereby allowing a dog owner to train and control the dog from a moderate distance without the use of a leash.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers), etc.

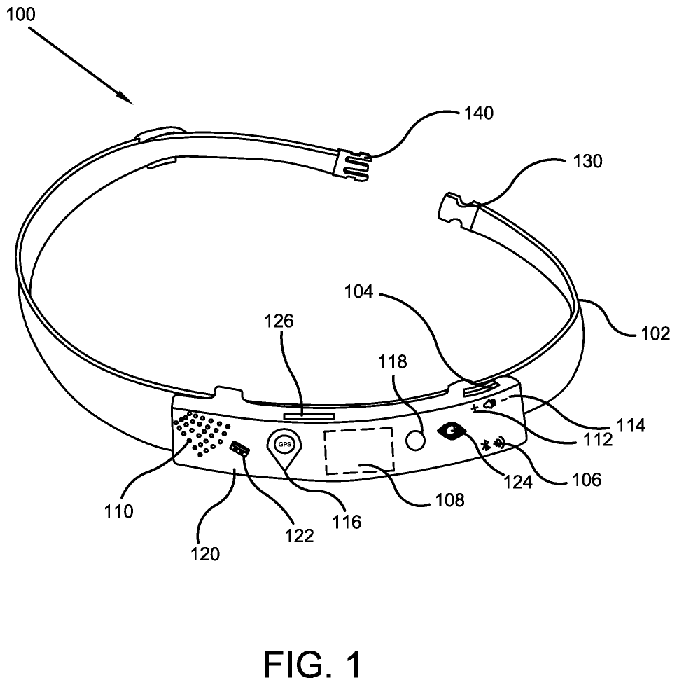

Referring initially to the drawings, FIG. 1 illustrates a perspective view of the wireless voice-controlled dog collar device of the present invention. The voice command collar device 100 is equipped with a built-in, one-way voice communication system paired with a transmitter to be used as a training tool. The collar device 100 comprises a nylon or polyester band 102 for wrapping around the neck of a dog or other pet, and has an appearance similar to a conventional dog collar for comfortable wearing of the collar device 100. The voice command collar device 100 also comprises a housing 120 that houses various electronic components of the collar device 100. Electronic components residing within the housing 120 are described later in the disclosure. The housing 120 is removably-secured to the band 102 allowing a dog owner to use the electronic components as per their preferences. The intelligent collar device 100 has wireless communication capability that supports training functions of the dog in cooperation with a companion training smartphone application or a handheld transmitter. More specifically, the voice command collar device 100 is configured to receive voice commands from the companion training smartphone application or the handheld transmitter for training the dog wearing the collar device 100. As stated earlier, the voice command collar device 100 has an elongated band 102 adapted to encircle the neck of a dog in a similar fashion as conventional dog collars known in the art. The band 102 can be made of a slash-proof and soft material such as nylon webbing, polyester, hemp, metal, etc., or any other suitable material as is known in the art.

The mobile command collar device 100 allows a dog owner to directly communicate with the dog wearing the collar device 100. Specifically, the collar device 100 is helpful in training a dog, thereby enabling the dog to receive clear and concise training commands while maintaining their freedom without a leash. The dog collar device 100 comprises a plurality of electronic components such as a control button 104, a wireless communication module 106, a vibration sensor 108, a speaker 110, a location detector chip 116, an internal memory 118, a USB charging port 122 and a camera 124 within the housing 120.

The control button 104 is used for activating or deactivating the electronic components, and can be used for activation when the dog is taken for a walk. For power-saving properties, the components can be deactivated when the collar device 100 is connected to a leash or is not worn by the dog. Also, the dog collar device 100 can be activated/deactivated using a wireless voice command from the dog owner.

The wireless communication module 106 is in the form of an integrated circuit or a microchip antenna and is configured to provide Bluetooth/Wi-Fi capabilities. The wireless communication module 106 established a wireless communication channel with an electronic device, thereby allowing the owner to transmit voice commands to the collar device 100 through the established wireless communication channel from a moderate distance. The moderate distance is generally defined as the distance within the range of technology of the established communication channel. Further, the vibration sensor 108 is designed to vibrate for a certain duration to stimulate the dog to perform a corresponding action. The vibration sensor 108 is also useful in places containing noise that may make it difficult for the dog to hear voice commands from the owner. The vibration sensor 108 can be one of a motor-drive based vibrator, a ceramic-based vibrator, a percussion-based vibrator, a transducer-based vibrator, or any other suitable vibrator as is known in the art. Additionally, the built-in speaker system 110 provides audible commands or instructions provided by the dog owner through their transmitters, either using a software application installed in an electronic device or through a handheld transmitter. Thus, the speaker system 110 plays out the audible commands, such as either a user's recorded voice or whistle tweets stored in the memory 118 of the collar device 100. Volume control buttons 112, 114 are also disposed on the housing 102 and are used for increasing and decreasing the volume of the speaker 110 respectively, as per the preferences of the dog and/or owner.

The voice command dog collar device 100 of the present invention has a built-in GPS chip 116 that determines the location of the dog collar device 100 and provides the location information to the dog owner using the wireless communication module 106. The location detector unit or built-in GPS chip 116 provides positional information to track the dog wearing the dog collar device 100 and is useful in cases when the dog wanders away.

The dog collar device 100 has an internal memory 118 for storing a plurality of pre-configured voice commands that can be played out via the built-in speaker system 110. Further, the dog collar device 100 also comprises a USB/mini-USB charging port 122 which is used for recharging an internal battery 126 that provides power to various components of the dog collar device 100.

The voice command dog collar device 100 of the present invention also comprises a built-in camera 124. The camera 124 captures still or moving images in an area in relative proximity to the collar device 100 and provides the images to the dog owner using the wireless communications module 106.

In use, the collar device 100 is secured around the neck of a dog via a buckle 130 and a clip 140, which mate together and are integrated into the band 102. Further, the buckle 130 may comprise a key-locking mechanism that locks the clip 140 into the buckle 130 when engaged. Additionally, any other type of fastening mechanism such as hook and loop, Velcro®, buckle, snap, etc., or any other mechanical fastener as is known in the art can be used for securing the ends of the band 102.

It is to be appreciated that the dog collar device 100 of the present invention can be used by novice dog owners to train their dogs and keep a check on them from a moderate distance. Also, professional dog trainers can use the voice command collar device 100 to train dogs and thus eliminates the need of a leash to control and train dogs. The wireless feature enables the dog owners to train, control and monitor their dogs wirelessly in a simplified manner using the voice commands.

The dog collar device 100 of the present invention is durable, non-slippery, waterproof and scratch-proof. The internal battery 126 of the dog collar device 100 runs for up to forty hours or more. In one embodiment, the collar device 100 may support built-in high-capacity lithium rechargeable batteries, however other suitable batteries may also be supported as are known in the art.

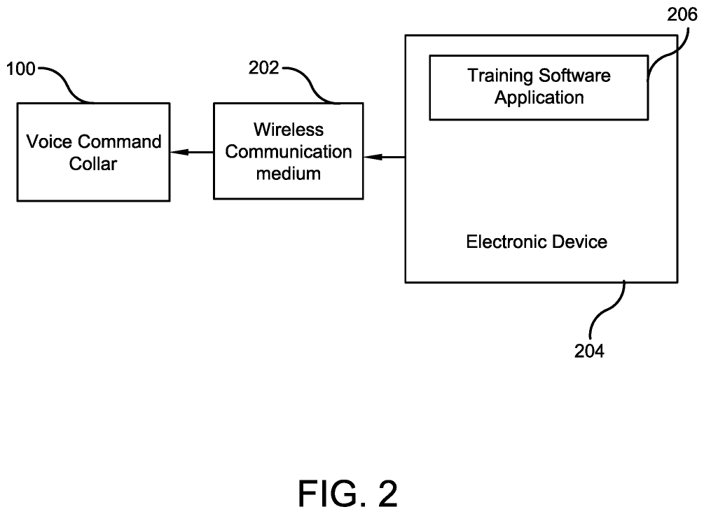

FIG. 2 illustrates a schematic view showing the wireless connection of the wireless voice-controlled dog collar device of the present invention with a paired smartphone application for receiving voice commands. As stated earlier, the voice command collar device 100 provides a one-way voice communication system for receiving voice commands from a paired training smartphone/software application 206. A user such as a dog owner provides the voice commands using a microphone of the electronic device 204, such as a smartphone or other mobile device, to train and command a dog wearing the voice command collar device 100. As shown in FIG. 2, the voice command collar device 100 connects to the electronic device 204 such as a smartphone, personal digital assistant or any other such type of electronic/mobile device using a wireless communication medium 202 such as Bluetooth, Wi-Fi or any other similar short-range or long-range wireless technology as is known in the art. The smartphone device 204 comprises an installed companion training software application 206 that receives information related to the dogs such as dog location, images relative to the band and other such type of information.

A dog owner can then give voice commands using the microphone of the smartphone 204, which is then received by the dog collar device 100 through the wireless communication medium 202. The voice command input by the dog owner is emitted in real-time by a speaker unit 110 (shown in FIG. 1) of the collar device 100, thereby enabling the dog to perform and train according to the emitted instruction.

It should be appreciated that dog owners can train and control their dog from a moderate distance without requiring a leash through the wireless voice commands. Further, the dog owner can also receive real-time information from the dog wearing the collar band device 100. The alert or notification shown on the software application 206 may be in the form of a push notification, audio alert, visual alert, etc., or any other suitable notification as is known in the art.

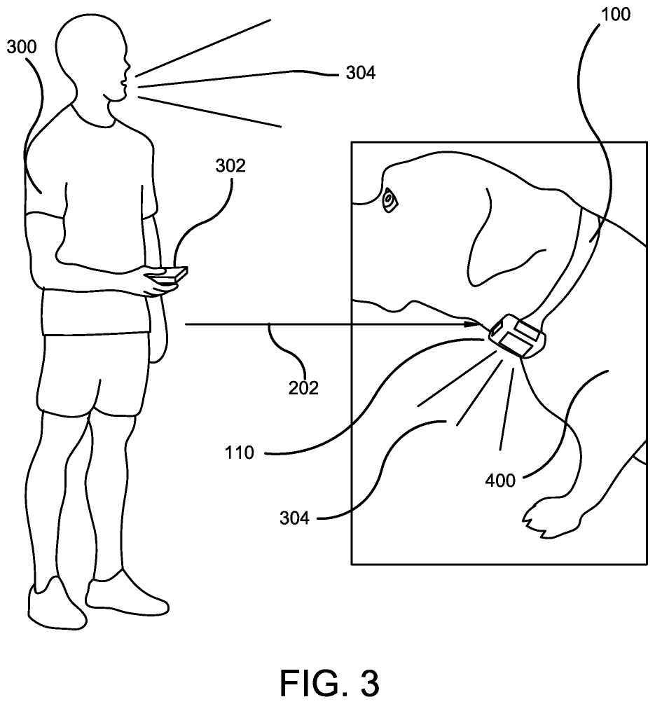

FIG. 3 illustrates a schematic view of the wireless voice-controlled dog collar device of the present invention receiving a voice command from the dog owner through a handheld transmitter. It should be noted that in the preferred embodiment, the handheld transmitter 302 can be commercially available with the dog collar device 100 of the present invention. A dog owner 300 uses the handheld transmitter 302 that is connected to the dog collar device 100 using the wireless communication channel 202 such as Bluetooth/Wi-Fi or any other short-range or long-range communication channel as is known in the art. The dog owner 300 gives a voice command 304 using the microphone of the handheld transmitter 302, and the voice command is received by the dog collar device 100 through the communication channel 202. The handheld transmitter 302 is compatible and paired to the voice command collar device 100, and allows the dog owner 300 to transmit voice commands 304 into the handheld transmitter 302 and then wirelessly transmit the voice commands 304 to the dog collar device 100 worn by the dog 400. The built-in speaker 110 of the dog collar device 100 emits the received voice commands 304 along with a beep/vibration corresponding to the voice commands 304 to alert the dog 400 to perform a certain action corresponding to the voice command 304. The dog owner 300 can then provide voice commands 304 such as sit, roll over, lie down or any other such type of commands as is known in the art for the dog to perform.

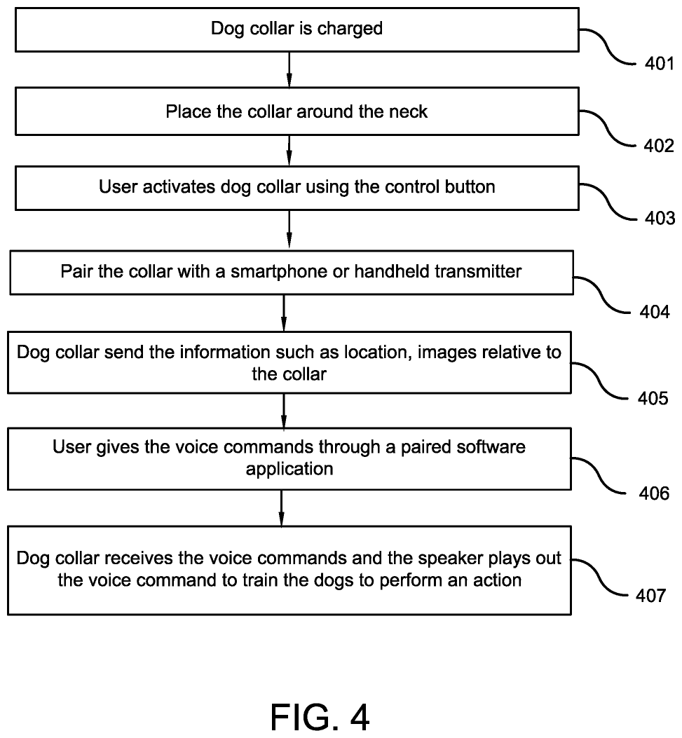

FIG. 4 illustrates an exemplary flow diagram showing the steps of use of the wireless voice-controlled dog collar device of the present invention for training and controlling dogs. Initially, at 401 the internal battery of the dog collar device of the present invention is charged using the USB-charging port of the collar device 100. At 402, in use, the dog collar device 100 is wrapped around the neck of a dog and at 403, the dog collar device 100 is activated via disposing a control button on the collar device 100. At 404, the collar is then either paired with a smartphone which comprises an installed training software application or with a handheld transmitter. At 405, the dog collar device 100 tracks the location information of the dog using the built-in GPS chip and captures the images or moving images of an area relative to the collar using the camera and sends the information to a user. At 406, the dog owner who is in possession of the paired smartphone or handheld transmitter gives one or more voice commands to the collar. At 407, upon receiving the voice command over a wireless communication medium, the speaker of the dog collar device 100 emits the voice command, stimulating the dog wearing the dog collar device 100 to perform an associated action.

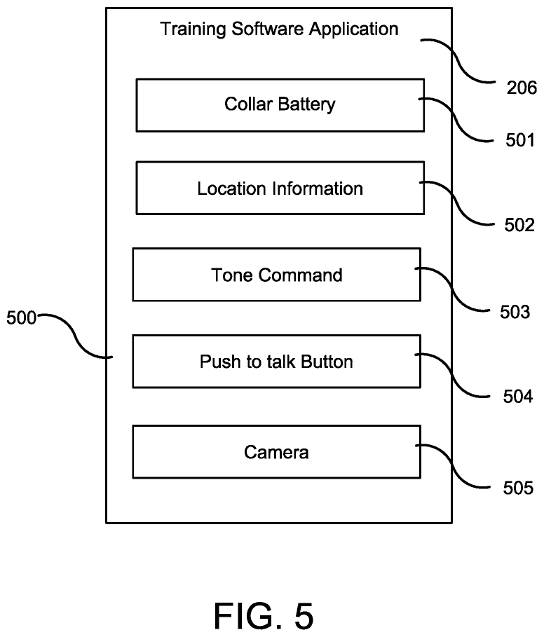

FIG. 5 illustrates an exemplary user interface of the training software application for communicating with the wireless voice-controlled dog collar device of the present invention. As shown in FIG. 5, the graphical interface 500 of the training software application 206 comprises a collar battery level indicator 501 that displays the battery charge level of voice command collar device 100 worn by a dog. The graphical interface 500 provides the user with location information 502 of the collar device that enables a dog owner to track the location of their dog. A “Tone Command” option 503 enables the dog owner to transmit prerecorded tones to the dog for training. The prerecorded tones can be a whistle, beep, etc., or any other suitable tones as is known in the art, and are the tones imbedded in the application or uploaded or prerecorded by the dog owner.

A “Push-to-Talk” button 504 enables dog owners to transmit real-time voice commands to the dog collar device 100. The “Push-to-Talk” button 504 is preferably depressed immediately before the voice command is spoken. Once spoken, the voice command is sent to the voice command collar device 100 using the wireless communication medium. The software application 206 also provides user with camera images 505 that are captured by the built-in camera of the voice command collar device 100. The captured images 505 are the still or moving images of an area relative to the collar, in whatever direction the dog is looking and provides the images to the dog owner through the wireless communications medium.

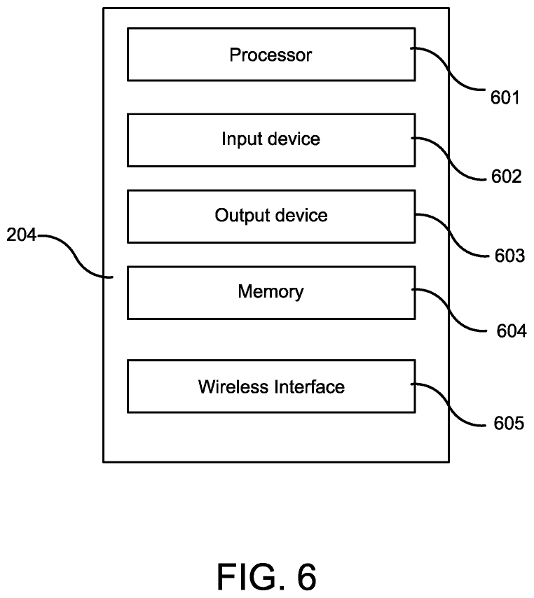

FIG. 6 illustrates an exemplary electronic device 204 upon which the training application 206 of the present disclosure is implemented. The electronic device 204 comprises several components such as a processor 601 configured to perform one or more functions described herein in accordance with the computer implemented instructions. The electronic device 204 also includes input device(s) 602 such as a mouse, keyboard, touch input device, voice input device, etc., for entering data and information. The electronic device 204 also includes one or more output device(s) 603 such as a monitor, presence-sensitive display, other display device, etc. The electronic device 204 comprises a memory 604 used for storing programs (i.e., sequences of instructions) or data (i.e., program state information) on a temporary or permanent basis for use in the computer system. The memory 604 can be configured for short-term storage of information as volatile memory, and therefore does not retain stored contents if powered off. Examples of volatile memories include random access memories (RAM), dynamic random-access memories (DRAM), static random-access memories (SRAM) and other forms of volatile memories as are known in the art. The processor 601, in combination with one or more of the memory 604, input device(s) 602 and output device(s) 603, is utilized to provide dog owners to be able to record and transmit voice commands to the dog collar device 100. The connection to a network is then provided by a wireless interface 605, which allows the transmitting of voice commands and the receiving of real-time alerts. Further, it should be appreciated that the same components and functionality are present in the handheld transmitter device as well.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wireless voice-controlled dog collar device”, “voice-controlled dog collar device”, “pet training collar device”, “dog collar device”, “collar device”, and “voice command collar device” are interchangeable and refer to the wireless voice-controlled dog collar device 100 of the present invention.

Notwithstanding the forgoing, the wireless voice-controlled dog collar device 100 of the present invention can be of any suitable size and configuration as is known in the art without affecting the overall concept of the invention, provided that it accomplishes the above-stated objectives. One of ordinary skill in the art will appreciate that the size, configuration and material of the wireless voice-controlled dog collar device 100 as shown in FIGS. 1-6 are for illustrative purposes only, and that many other sizes and shapes of the wireless voice-controlled dog collar device 100 are well within the scope of the present disclosure. Although the dimensions of the wireless voice-controlled dog collar device 100 are important design parameters for user convenience, the wireless voice-controlled dog collar device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A voice command collar device used as a training tool for a dog or other pet, the voice command collar device comprising:
a band for wrapping around a neck of the dog or other pet; and
a housing secured to the band, wherein the housing comprises a control button, a wireless communication module, a vibration sensor, a speaker, a location detector chip and an internal memory; and
wherein a user directly communicates with the dog or other pet wearing the voice command collar device from a moderate distance via the wireless communication module without requiring a leash; and
wherein a user receives real time information from the dog or other pet wearing the voice command collar device via the wireless communication module.

2. The voice command collar device of claim 1 further comprising a USB charging port and a camera, wherein the wireless communication module that supports training functions of the dog or other pet is in wireless communication with a companion training smartphone application.

3. The voice command collar device of claim 1 further comprising utilizing the wireless communication module that supports training functions of the dog or other pet in cooperation with a handheld transmitter.

4. The voice command collar device of claim 2, wherein the voice command collar device is configured to receive voice commands from the companion training smartphone application or the handheld transmitter.

5. The voice command collar device of claim 4, wherein the wireless communication module comprises an integrated circuit or microchip antenna and is configured to provide Bluetooth/Wi-Fi capabilities.

6. The voice command collar device of claim 5, wherein the wireless communication module establishes a wireless communication channel with an electronic device allowing a user to transmit voice commands to the voice command collar device.

7. The voice command collar device of claim 6, wherein the moderate distance is defined as a distance within a range of technology of the established wireless communication channel.

8. The voice command collar device of claim 1, wherein the vibration sensor vibrates for a certain duration to stimulate the dog or other pet to perform a corresponding action.

9. The voice command collar device of claim 1, wherein the speaker emits audible commands from the user.

10. The voice command collar device of claim 1, wherein the location detector chip determines location of the dog or other pet and provides the location to the user via the wireless communication module.

11. The voice command collar device of claim 1, wherein the internal memory stores a plurality of preconfigured voice commands that can be emitted via the speaker.

12. The voice command collar device of claim 2, wherein the USB charging port is used for recharging an internal battery.

13. The voice command collar device of claim 2, wherein the camera captures still or moving images in an area relative to the band and provides the images to the user using the wireless communications module.

14. A voice command collar device used as a training tool for a dog or other pet, the voice command collar device comprising:
a band for wrapping around a neck of the dog or other pet; and
a housing secured to the band, wherein the housing comprises a control button, a wireless communication module, a vibration sensor, a speaker, a location detector chip and an internal memory; and
wherein the voice command collar device receives voice commands in real time from a paired training smartphone;
wherein the voice command collar device connects to the paired training smartphone using the wireless communication module; and
wherein the speaker emits the received voice commands along with a vibration corresponding to the received voice commands to alert the dog or other pet to perform a certain action corresponding to the received voice commands.

15. The voice command collar device of claim 14 further comprising a USB charging port and a camera, wherein the paired training smartphone comprises an installed companion training software application that receives information related to the dog or other pet.

16. The voice command collar device of claim 15, wherein the user provides the voice commands using a microphone of the paired training smartphone to train and command the dog or other pet wearing the voice command collar device.

17. The voice command collar device of claim 14 wherein the voice commands are received from a handheld transmitter.

18. The voice command collar device of claim 15 further comprising a user interface of the installed companion training software application, wherein the user interface comprises a collar battery level indicator, a location information, a tone command, a push to talk button and a camera.

19. The voice command collar device of claim 18, wherein the paired training smartphone comprises a processor, at least one input device from a group consisting of a mouse, a keyboard, a touch input device and a voice input device, and at least one output device from a group consisting of a monitor, a presence-sensitive display, a memory and a wireless interface.

20. The method of using a wirelessly voice command collar device comprising the steps of:
charging an internal battery of the wirelessly voice command collar device using a USB-charging port;
placing the wirelessly voice command collar device around a neck of a pet;
activating the wirelessly voice command collar device via disposing a control button;
pairing the wirelessly voice command collar device with a smartphone which comprises an installed training software application or with a handheld transmitter;
tracking a location information of the pet using a built-in location chip;
transmitting voice commands via the paired smartphone or handheld transmitter to the wirelessly voice command collar device;
receiving the voice commands over a wireless communication medium;
emitting the voice commands via a speaker on the wirelessly voice command collar device; and
stimulating the pet wearing the wirelessly voice command collar device to perform an associated action.
